(19) United States
(12) Patent Application Publication
(10) Pub. No.: US 2007/0248277 A1
(43) Pub. Date: Oct. 25, 2007

(54) Method And System For Processing Image Data

(76) Inventors: Michael A. Scrofano, McKinney, TX (US); David U. Fluckiger, Allen, TX (US); Brad W. Fennell, McKinney, TX (US); Barry M. Wallace, Garland, TX (US)

Correspondence Address: BAKER BOTTS LLP, 2001 ROSS AVENUE, 6TH FLOOR, DALLAS, TX, 75201-2980, US

(21) Appl. No.: 11/379,896

(22) Filed: Apr. 24, 2006

(51) Int. Cl. G06K 9/40

(52) U.S. Cl. 382/260

(57) ABSTRACT

Processing image data includes receiving image data corresponding to an image, where the image data describes a number of pixels. A blurring filter is applied to the image data, where the blurring filter reduces contrast between at least some of the pixels. A stretching filter is applied to the image data, where the stretching filter increases the number of pixels. A sharpening filter is applied to the image data, where the sharpening filter increases contrast between at least some of the pixels.

### TECHNICAL FIELD OF THE INVENTION

This invention relates generally to the field of imaging systems and more specifically to a method and system for processing image data.

### BACKGROUND OF THE INVENTION

An imaging system typically forms an image on a display using image data generated from sensor data. In certain cases, the resolution of the sensor data may not be sufficient to generate an image having satisfactory image quality. In these cases, the image data may be processed to improve the human eye perceived resolution and quality of the resulting image. Known techniques for processing the image data include applying filters such as stretching and sharpening filters to the image data. These known techniques, however, do not effectively provide satisfactory image quality in certain situations. It is generally desirable to effectively provide satisfactory image quality in certain situations.

### SUMMARY OF THE INVENTION

According to one embodiment of the present invention, a method for processing image data includes receiving image data corresponding to an image, where the image data describes a number of pixels. A blurring filter is applied to the image data, where the blurring filter reduces contrast between at least some of the pixels. A stretching filter is applied to the image data, where the stretching filter increases the number of pixels. A sharpening filter is applied to the image data, where the sharpening filter increases contrast between at least some of the pixels.

According to one embodiment of the present invention, a system for processing image data includes a blurring module, a stretching module, and a sharpening module. The blurring module receives image data corresponding to an image, where the image data describes a number of pixels. The blurring module also applies a blurring filter to the image data, where the blurring filter reduces contrast between at least some of the pixels. The stretching module applies a stretching filter to the image data, where the stretching filter increases the number of pixels. The sharpening module applies a sharpening filter to the image data, where the sharpening filter increases contrast between at least some of the pixels.

Certain embodiments of the invention may provide numerous technical advantages. A technical advantage of one embodiment may be that a blurring filter may be applied prior to applying a stretching filter. Applying the blurring filter prior to applying the stretching filter may reduce spatial aliasing. Reducing spatial aliasing may provide for easier viewing by an observer.

Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram illustrating one embodiment of a system that processes image data to yield an image;

FIG. 2 is a block diagram illustrating one embodiment of an image processor that may be used with the system of FIG. 1; and

FIG. 3 is a flowchart illustrating one embodiment of a method for possessing image data that may be used with the system of FIG. 1 and the image processor of FIG. 2.

### DETAILED DESCRIPTION OF THE DRAWINGS

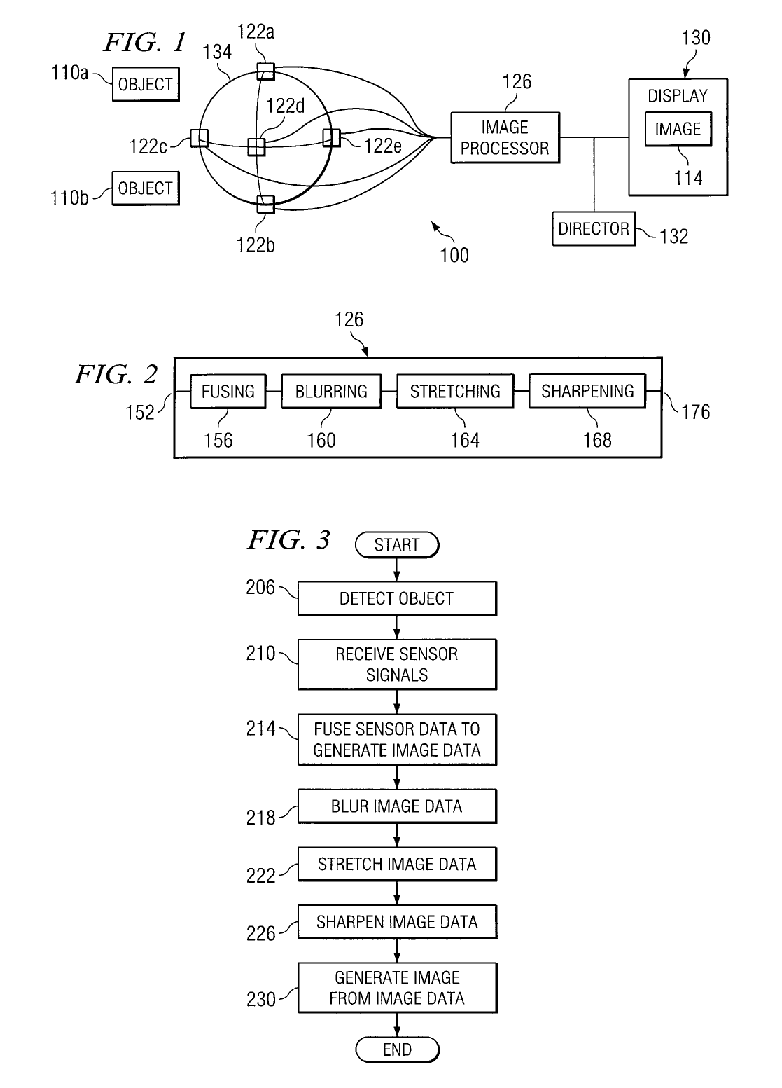

Embodiments of the present invention and its advantages are best understood by referring to FIGS. 1 through 3 of the drawings, like numerals being used for like and corresponding parts of the various drawings.

FIG. 1 is a block diagram illustrating one embodiment of a system 100 that processes image data to yield an image. According to the embodiment, system 100 may process the image data by applying a blurring filter, a stretching filter, and a sharpening filter to the image data, which may improve the resolution of the resulting image. Applying the blurring filter prior to applying the stretching filter may reduce spatial aliasing, which may provide for easier viewing by an observer.

According to the illustrated embodiment, system 100 receives light reflected from an object 110 and generates an image 114 of object 110. System 100 includes sensors 122, an image processor 126, and a display 130 coupled as shown. According to one embodiment of operation, sensors 122 generate sensor data in response to detecting light reflected from object 110. Image processor 126 processes image data generated from the sensor data, which may improve the resolution of image 114. Image 114 is formed on display 118 according to the image data.

According to one embodiment, object 110 comprises any suitable living or non-living thing comprising any suitable material or materials, and having a surface that reflects light. Object 110 may be at any suitable location, such as on, above, or below the ground.

According to one embodiment, a sensor 122 detects light reflected from object 110 and generates sensor data in response to the detected light. Sensor 122 may detect any suitable wavelengths of the light, for example, visible or infrared wavelengths. Sensor 122 may include an image sensor that enhances certain features of light, such as an image intensifier image sensor. Example sensors 122 may include a video camera, a low light level charge coupled device (LLLCCD), or a complementary metal-oxide semiconductor (CMOS) image sensor.

System 100 may include any suitable number of sensors 122 arranged on any suitable abstract surface 134 in any suitable manner. According to one embodiment, sensors 122 may form a distributed aperture sensor. Sensors 122 may be arranged to provide a particular field of view, such as a substantially spherical or partially spherical field of view. As an example, six sensors 122 may be arranged on each surface of abstract surface 134 shaped like a cube to provide a substantially spherical field of view.

Abstract surface 134 may represent an actual surface to which sensors 122 may be coupled. According to one embodiment, abstract surface 134 may represent the surface of a stationary or moving platform for sensors 122. A stationary platform may be used to detect objects 110 in a particular area. As an example, sensors 122 and the stationary platform may form a surveillance system that provides security for the area. A moving platform may be used to detect objects 110 across an area. As an example, the moving object may comprise a vehicle that is used to detect objects 110 across a region. Example vehicles include aircraft, automobiles, and marine craft.

Image processor 126 processes image data generated from the sensor data from one, some, or all sensors 122. In certain situations, distributed aperture sensors may yield image 114 with reduced resolution. Accordingly, image processor 122 may process image data to improve the resolution of image 114. Image processor 122 is described in more detail with reference to FIG. 2.

According to one embodiment, image processor 126 may process the image data by applying a blurring filter, a stretching filter, and a sharpening filter to the image data. Applying the blurring filter prior to applying the stretching filter may reduce spatial aliasing, which may provide for easier viewing by an observer. Typically, the human eye focuses on the edges of an image to identify objects within an image. Spatial aliasing, however, yields edges that are not relevant to the identification of objects, and may cause the human eye to unnecessarily expend effort. Accordingly, reducing spatial aliasing may provide for easier viewing by an observer.

Director 132 may be used to select sensors 122 from which sensor data is used to generate image data. Director 132 may be used to select one, some, or all sensors 122a-e. As an example, sensor 122a may be selected to detect object 110a, or sensor 122b may be selected to detect object 110b. Multiple sensors may be selected to detect one or more objects. As an example, sensors 122a and 122c may be used to detect object 110a, or sensors 122a, 122b, and 122c may be used to detect objects 110a and 110b.

Display 130 displays image 114 of object 130. Examples of display 130 may include an organic light-emitting diode (OLED), a nematic liquid-crystal display (LCD), or a field emitting display (FED) in a panel display, an eyepiece display, or a near-to-eye display format.

According to one embodiment, display 130 and director 132 may be embodied in headgear, for example, a helmet, that may be worn by an observer. Director 132 may detect the field of view of observer, and may select one or more sensors 122 that sense substantially in the field of view. Sensor data from the selected sensors 122 may be used to generate image 114 that substantially corresponds to the field of view of the observer. Display 130 may display image 114 to the observer.

One or more components of system 10 may include appropriate input devices, output devices, mass storage media, processors, memory, or other components for receiving, processing, storing, or communicating information according to the operation of system 10. As an example, one or more components of system 10 may include logic, an interface, memory, other component, or any suitable combination of the preceding.

“Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations. “Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 100 without departing from the scope of the invention. The components of system 100 may be integrated or separated according to particular needs. Moreover, the operations of system 100 may be performed by more, fewer, or other modules. For example, the operations of image processor 126 and display 130 may be performed by one module, or the operations of image processor 126 may be performed by more than one module. Additionally, operations of system 100 may be performed using any suitable logic. “Each” as used in this document means each member of a set or each member of a subset of the set.

FIG. 2 is a block diagram illustrating one embodiment of image processor 126 that may be used with system 100 of FIG. 1. According to the embodiment, image processor 126 may process image data by applying a blurring filter, a stretching filter, and a sharpening filter to the image data.

According to the illustrated embodiment, image processor 126 includes an input 152, a fusing module 156, a blurring module 160, a stretching module 164, a sharpening module 168, and an output 176 coupled as shown.

Input 152 receives sensor signals from one or more selected sensors 122. The sensors 122 may be selected in accordance with instructions from director 132 of FIG. 1. The sensor signals carry sensor data from which image data may be generated.

Fusing module 156 fuses sensor data to generate image data. The sensor data may be fused in any suitable manner. As an example, sensor data corresponding to side-by-side images 114 may be stitched together to yield image data corresponding to a larger image 114 comprising the side-by-side images 114. As another example, sensor data corresponding to at least partially overlapping images 114 may be overlapped to yield image data corresponding to an image 114 comprising the overlapping images 114. Sensor data may be overlapped by calculating pixel values for the fused sensor data from corresponding pixel values of the sensor data.

Image data may refer to data from which image 114 may be generated. Image data may have any suitable format. According to one embodiment, image data may comprise a matrix of entries, where each entry corresponds to a pixel. The entries may include pixel values for image parameters. An image parameter describes a feature of an image, for example, color, intensity, or saturation. A pixel value of a pixel describes the value of the image parameter for the pixel, for example, a particular color, intensity, or saturation. In certain cases, the value of a pixel may be calculated from the values of one or more neighboring pixels. A neighboring pixel of a target pixel may be any suitable number of hops away from the target pixel, for example, one-hop, two-hops, etc.

Blurring module 160 applies a blurring filter to the image data to blur image 114. A blurring filter may decrease the contrast between adjacent or nearby pixels, which may reduce the contrast of the edges of image 114. Blurring the image data may also reduce the high frequency content of the image data, which may allow the image data to be stretched and sharpened with reduced or eliminated spatial aliasing. Any suitable n×m portion of the image data may be blurred, where n and m represent numbers of pixels.

According to one embodiment, blurring module 160 may apply a Gaussian blur filter. A Gaussian blur filter uses a Gaussian distribution for calculating a transformation to apply to a pixel. A Gaussian distribution may be given by the following equation:

$${G}_{r} = \frac{1}{\sqrt{2 π} σ} {ⅇ}^{\frac{- {r}^{2}}{2 {σ}^{2}}}$$

where r represents the blur radius, and a represents the standard deviation of the Gaussian distribution. Blur radius r is used to set the scale of the detail to be removed. In general, a smaller blur radius r removes finer detail, while a larger blur radius r removes coarser detail.

For image data of two dimensions, the Gaussian blurring filter yields a surface with contours that are concentric circles, where each circle has a Gaussian distribution from the center point. Pixels that have a distribution that is non-zero may be used to generate a convolution matrix, which is applied to the original image data.

The value at each pixel may be set to a weighted average of the values of the pixel and the neighboring pixels. As an example, for a target pixel, the pixel values may be given weights that are inversely proportional to the distance between the pixels and the target pixel, where the value of the target pixel receives the largest weight. According to one embodiment, pixels outside of approximately 3σ may be considered to be effectively zero and may be ignored.

Stretching module 164 applies a stretching filter to the image data. A stretching filter increases the number of pixels of the image data by adding pixels. The values of the added pixels may be calculated from the values of neighboring pixels. The number of pixels may be increased any suitable number of times. As an example the number of pixels may be doubled, tripled, or quadrupled.

Any suitable stretching filter may be used to stretch the image data. Examples of stretching filters include pixels replication, linear interpolation, cubic interpolation, other stretching filter, or any combination of the preceding.

According to one embodiment, an interpolation stretching filter may be used. An interpolation stretching filter uses interpolation to determine the values of the added pixels from the values of the neighboring pixels. Linear interpolation calculates the value of an added pixel from one-hop neighboring pixels. Cubic interpolation calculates the value of an added pixel from one-hop and two-hop neighboring pixels.

Sharpening module 168 applies a sharpening filter to the image data to increase the contrast of the edges of image 114. The specific filters may be selected according to the specific application. As an example, certain filters may be selected to generate image data that will ultimately be viewed by the human eye, and other filters may be selected to generate image data to be used by a computer. Output 176 outputs the processed image data to display 130, which generates image 114 from the image data.

Modifications, additions, or omissions may be made to image processor 126 without departing from the scope of the invention. The components of image processor 126 may be integrated or separated according to particular needs. Moreover, the operations of image processor 126 may be performed by more, fewer, or other modules. For example, the operations of blurring module 160 and stretching module 164 may be performed by one module, or the operations of blurring module 160 may be performed by more than one module. Additionally, operations of image processor 126 may be performed using any suitable logic.

FIG. 3 is a flowchart illustrating one embodiment of a method for processing image data that may be used with the system of FIG. 1 and the image processor of FIG. 2.

The method starts at step 206, where object 110 is detected by sensors 122. According to the embodiment, sensors 122 detect object 110 and generate sensor signals carrying sensor data describing object 110. Sensor signals are received at step 210. According to the embodiment, input 152 of image processor 126 may receive the sensor signals from selected sensors 122.

Sensor data are fused at step 214 to generate image data. According to the embodiment, fusing module 156 may fuse the sensor data from multiple sensors 122 to generate image data for image 114.

The image data is blurred at step 218. According to the embodiment, blurring module 160 may apply a blurring filter to the image data to blur image 114. Blurring image 114 may decrease the contrast between adjacent or nearby pixels, which may reduce the contrast of the edges of image 114. Blurring the image data may also reduce the high frequency content of the image data, which may allow the image data to be stretched and sharpened with reduced or eliminated spatial aliasing.

The image data is stretched at step 222. According to the embodiment, stretching module 164 may apply a stretching filter to the image data. A stretching filter increases the number of pixels of the image data by adding pixels and calculating the values of the added pixels from the values of the neighboring pixels.

The image data is sharpened at step 226. According to the embodiment, sharpening module 168 may apply a sharpening filter to the image data to increase the contrast of the edges of image 114. Image 114 is generated from the image data at step 230. According to the embodiment, display 130 may generate image 114 from the image data. After generating image 114, the method ends.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide numerous technical advantages. A technical advantage of one embodiment may be that a blurring filter may be applied prior to applying a stretching filter. Applying the blurring filter prior to applying the stretching filter may reduce spatial aliasing. Reducing spatial aliasing may provide for easier viewing by an observer.

Although an embodiment of the invention and its advantages are described in detail, a person skilled in the art could make various alterations, additions, and omissions without departing from the spirit and scope of the present invention as defined by the appended claims.

What is claimed is:

1. A method for processing image data, comprising:
receiving image data corresponding to an image, the image data describing a number of pixels;
applying a blurring filter to the image data, the blurring filter reducing contrast between at least some of the pixels;
applying a stretching filter to the image data, the stretching filter increasing the number of pixels; and
applying a sharpening filter to the image data, the sharpening filter increasing contrast between at least some of the pixels.

2. The method of claim 1, further comprising:
receiving sensor data from one or more sensors; and
fusing the sensor data to yield the image data.

3. The method of claim 1, wherein applying the blurring filter to the image data further comprises:
applying a Gaussian blurring filter, the Gaussian blurring filter calculating a pixel transformation according to a Gaussian distribution.

4. The method of claim 1, wherein applying the stretching filter to the image data further comprises:
applying an interpolation stretching filter, the interpolation stretching filter interpolating one or more values of one or more neighboring pixels to determine a value for an added pixel.

5. The method of claim 1, wherein applying the stretching filter to the image data further comprises:
applying a cubic interpolation stretching filter, the cubic interpolation stretching filter interpolating one or more values of one or more one-hop neighboring pixels and one or more two-hop neighboring pixels to determine a value for an added pixel.

6. The method of claim 1, wherein applying the sharpening filter to the image data further comprises:
applying a filter selected in accordance with a particular application.

7. The method of claim 1, wherein applying the sharpening filter to the image data further comprises:
applying a filter selected in accordance with viewing by a human eye.

8. The method of claim 1, wherein applying the sharpening filter to the image data further comprises:
applying a filter selected in accordance with use by a computer.

9. The method of claim 1, further comprising:
receiving sensor data from a plurality of sensors, the plurality of sensors forming a distributed aperture sensor; and
generating the image data from the sensor data from at least one sensor of the plurality of sensors.

10. A system for processing image data, comprising:
a blurring module operable to:
receive image data corresponding to an image, the image data describing a number of pixels;
apply a blurring filter to the image data, the blurring filter reducing contrast between at least some of the pixels;
a stretching module coupled to the blurring module and operable to:
apply a stretching filter to the image data, the stretching filter increasing the number of pixels; and
a sharpening module coupled to the stretching module and operable to:
apply a sharpening filter to the image data, the sharpening filter increasing contrast between at least some of the pixels.

11. The system of claim 10, further comprising a fusing module operable to:
receive sensor data from one or more sensors; and
fuse the sensor data to yield the image data.

12. The system of claim 10, the blurring module operable to apply the blurring filter to the image data by:
applying a Gaussian blurring filter, the Gaussian blurring filter calculating a pixel transformation according to a Gaussian distribution.

13. The system of claim 10, the stretching module operable to apply the stretching filter to the image data by:
applying an interpolation stretching filter, the interpolation stretching filter interpolating one or more values of one or more neighboring pixels to determine a value for an added pixel.

14. The system of claim 10, the stretching module operable to apply the stretching filter to the image data by:
applying a cubic interpolation stretching filter, the cubic interpolation stretching filter interpolating one or more values of one or more one-hop neighboring pixels and one or more two-hop neighboring pixels to determine a value for an added pixel.

15. The system of claim 10, the sharpening module operable to apply the sharpening filter to the image data by:
applying a filter selected in accordance with a particular application.

16. The system of claim 10, the sharpening module operable to apply the sharpening filter to the image data by:
applying a filter selected in accordance with viewing by a human eye.

17. The system of claim 10, the sharpening module operable to apply the sharpening filter to the image data by:
applying a filter selected in accordance with use by a computer.

18. The system of claim 10, further comprising a fusing module operable to:
receive sensor data from a plurality of sensors, the plurality of sensors forming a distributed aperture sensor; and
generate the image data from the sensor data from at least one sensor of the plurality of sensors.

19. A system for processing image data, the method comprising:
means for receiving image data corresponding to an image, the image data describing a number of pixels;
means for applying a blurring filter to the image data, the blurring filter reducing contrast between at least some of the pixels;
means for applying a stretching filter to the image data, the stretching filter increasing the number of pixels; and
means for applying a sharpening filter to the image data, the sharpening filter increasing contrast between at least some of the pixels.

20. A system for processing image data, comprising:
a fusing module operable to:
receive sensor data from a plurality of sensors, the plurality of sensors forming a distributed aperture sensor; and
fuse the sensor data from at least one sensor of the plurality of sensors to yield image data;
a blurring module operable to:
receive the image data corresponding to an image, the image data describing a number of pixels;
apply a blurring filter to the image data, the blurring filter reducing contrast between at least some of the pixels, the blurring module further operable to apply the blurring filter to the image data by:
applying a Gaussian blurring filter, the Gaussian blurring filter calculating a pixel transformation according to a Gaussian distribution;
a stretching module coupled to the blurring module and operable to:
apply a stretching filter to the image data, the stretching filter increasing the number of pixels, the stretching module further operable to apply the stretching filter to the image data by:
applying an interpolation stretching filter, the interpolation stretching filter interpolating one or more values of one or more neighboring pixels to determine a value for an added pixel; and
applying a cubic interpolation stretching filter, the cubic interpolation stretching filter interpolating one or more values of one or more one-hop neighboring pixels and one or more two-hop neighboring pixels to determine a value for an added pixel; and
a sharpening module coupled to the stretching module and operable to:
apply a sharpening filter to the image data, the sharpening filter increasing contrast between at least some of the pixels, the sharpening module further operable to apply the sharpening filter to the image data by:
applying a filter selected in accordance with a particular application;
applying a filter selected in accordance with viewing by a human eye; and
applying a filter selected in accordance with use by a computer.
